(19) United States
(12) Patent Application Publication
(10) Pub. No.: US 2022/0129924 A1
(43) Pub. Date: Apr. 28, 2022

(54) ELECTRONIC DEVICE AND CONTROL METHOD THEREFOR

(71) Applicant: SAMSUNG ELECTRONICS CO., LTD, Suwon-si (KR)

(72) Inventors: Laura KANG, Suwon-si (KR); Hayoung KIM, Seongnam-si (KR)

(73) Assignee: SAMSUNG ELECTRONICS CO., LTD, Suwon-si (KR)

(21) Appl. No.: 17/432,802

(22) PCT Filed: Dec. 26, 2019
(86) PCT No.: PCT/KR2019/018493

§ 371 Date: Aug. 20, 2021

(30) Foreign Application Priority Data
Mar. 4, 2019 (KR) 10-2019-0024874

(51) Int. Cl. G06Q 30/02; G06N 3/08; G06N 3/04

(52) U.S. Cl. CPC G06Q 30/0202; G06N 3/0454; G06N 3/08; G06Q 30/0201

(57) ABSTRACT

An electronic device and a control method therefor are provided. The electronic device comprises: a memory in which a first AI model and a second AI model are stored; and a processor which: acquires data indicating ratios of monthly predicted sales of respective products to monthly predicted sales amounts of multiple products within a particular period after a current time point by using the first AI model; acquires data indicating a ratio of monthly predicted sales of multiple products to all sales amounts of multiple products within a particular period after a current time point by using the second AI model; and calculates ratios of monthly predicted sales of respective products to all predicted sales amounts of multiple products within a particular period based on the acquired data.

### CROSS-REFERENCE TO RELATED APPLICATION(S)

This application is based on and claims priority under 35 U.S.C. § 119 to Korean Patent Application No. 10-2019-0024874 and PCT Application No. PCT/KR2019/018493, filed on Mar. 4, 2019 and Dec. 26, 2019, respectively, in the Korean Intellectual Property Office, the disclosure of which is incorporated by reference herein in its entirety.

### BACKGROUND

### 1. Field

This disclosure relates to an electronic device and a control method therefor and, more specifically, to an electronic device for predicting a sales ratio of a product by using various data related to sales of a product, and a control method therefor.

This disclosure relates to an artificial intelligence (AI) system that simulates a function of human brain such as cognition, determination, or the like, using a machine learning algorithm, and an application thereof.

### 2. Description of Related Art

These days, various electronic products are released as the needs of a consumer are diversified, and a cycle of release and sales of a new electronic product has been shortened.

Accordingly, there is a need for a technology for accurately predicting an amount of sales of a product and producing a product accordingly, to sell and distribute a product economically and efficiently.

With the recent development of e-commerce, a large amount of sales data is accumulated as a sales path, a sales strategy, a sales price, or the like, are diversified, and a product sales and supply network management technology is more complicated based on the accumulated data.

In recent years, AI systems which realize human-level intelligence have been used in various fields. An AI system is a system in which a machine learns, judges, and becomes smart, unlike an existing rule-based smart system. As the use of AI systems improves, a recognition rate and understanding or anticipation of a user's taste may be performed more accurately. As such, existing rule-based smart systems are gradually being replaced by deep learning-based AI systems.

The AI technology is composed of machine learning (for example, deep learning) and element technologies which utilize machine learning.

Machine learning is an algorithm technology that classifies/learns the characteristics of input data by itself. Element technology is a technology that simulates functions such as recognition and determination of human brain using machine learning algorithms such as deep learning, composed of linguistic understanding, visual understanding, reasoning/prediction, knowledge representation, motion control, etc.

Various fields in which AI technology is applied are as follows. Linguistic understanding is a technology for recognizing, applying/processing human language/characters and includes natural language processing, machine translation, dialogue system, question & answer, speech recognition/synthesis, and the like. Visual understanding is a technique for recognizing and processing objects as human vision, including object recognition, object tracking, image search, human recognition, scene understanding, spatial understanding, image enhancement, and the like. Inference prediction is a technique for judging and logically inferring and predicting information, including knowledge/probability based inference, optimization prediction, preference-based planning, and recommendation. Knowledge representation is a technology for automating human experience information into knowledge data, including knowledge building (data generation/classification) and knowledge management (data utilization). The motion control is a technique for controlling the autonomous running of the vehicle and the motion of the robot, including motion control (navigation, collision, driving), operation control (behavior control), and the like).

As described above, an attempt to apply an AI technology to a product sales and supply network management system emerges, as a field to which the AI technology is applied is diversified and the product sales and supply network management are complicated.

### SUMMARY

It is an object of the disclosure to provide an electronic device which may predict a sales amount or sales ratio of a product after the present, more efficiently and accurately based on an AI model trained by using various data related to sales of a product, and a control method therefor.

According to an aspect of an example embodiment, an electronic device may include a memory configured to store a first artificial intelligence (AI) model and a second AI model; and a processor configured to: obtain first data indicating first ratios of monthly predicted sales of respective products of a plurality of products to monthly predicted sales amounts of the plurality of products within a particular period after a current time point by inputting data indicating a monthly sales ratio of each of the plurality of products obtained during a predetermined period before the current time point into the first AI model, obtain second data indicating second ratios of monthly predicted sales of the plurality of products to all predicted sales amounts of the plurality of products within the particular period after the current time point by inputting data indicating monthly sales amounts of the plurality of products during a predetermined period before the current time point into the second AI model, and calculate monthly predicted sales ratios of the respective products to the all predicted sales amounts of the plurality of products in the particular period based on the first data and the second data. The first AI model comprises a neural network model that is different from the second AI model.

The first AI model is a model trained to predict the monthly sales ratio of respective products of the plurality of products within the particular period based on data related to sales ratios of the respective products to the sales amounts of the plurality of products in a particular month and data related to monthly sales ratios of the respective products to the monthly sales amounts of the plurality of products during a predetermined period in the past prior to the particular month.

The data related to the monthly sales ratios of the plurality of products comprises data indicating at least one of monthly sales ratios of respective products during the predetermined period, sales ratios of the respective products sold on a monthly basis to a place of sales during the predetermined period, and sales ratios of the respective products expected to be sold on a monthly basis by the place of sales.

The second AI model is trained to predict the monthly sales ratios of the plurality of products within the particular period based on the data indicating the monthly sales amounts of the plurality of products during the predetermined period in the past prior to a particular year.

The processor is further configured to calculate monthly predicted sales ratios of respective products to all predicted sales amounts of the plurality of products in the particular period by multiplying the monthly predicted sales ratios of the respective products in the particular period obtained from the first AI model by the monthly predicted sales ratios of the plurality of products obtained from the second AI model.

The first model comprises a model based on a convolution neural network (CNN), and the second model comprises a model based on a recurrent neural network (RNN).

According to an aspect of an example embodiment, a method of controlling an electronic device may include obtaining first data indicating first ratios of monthly predicted sales of respective products of a plurality of products to monthly predicted sales amounts of the plurality of products within a particular period after a current time point by inputting data indicating a monthly sales ratio of each of the plurality of products obtained during a predetermined period before the current time point into a first artificial intelligence (AI) model; obtaining second data indicating second ratios of monthly predicted sales of the plurality of products to all predicted sales amounts of the plurality of products within a particular period after the current time point by inputting data indicating monthly sales amounts of the plurality of products during a predetermined period before the current time point into a second AI model; and calculating monthly predicted sales ratios of the respective products to the all predicted sales amounts of the plurality of products in the particular period based on the first data and the second data. The first AI model comprises a neural network model different from the second AI model.

The first AI model is a model trained to predict the monthly sales ratio of respective products of the plurality of products within the particular period based on data related to sales ratios of the respective products to the sales amounts of the plurality of products in a particular month and data related to monthly sales ratios of the respective products to the monthly sales amounts of the plurality of products during a predetermined period in the past prior to the particular month.

The data related to the monthly sales ratios of the plurality of products comprises data indicating at least one of monthly sales ratios of respective products during the predetermined period, sales ratios of the respective products sold on a monthly basis to a place of sales during the predetermined period, and sales ratios of the respective products expected to be sold on a monthly basis by the place of sales.

The second AI model is trained to predict the monthly sales ratios of the plurality of products within the particular period based on the data indicating the monthly sales amounts of the plurality of products during the predetermined period in the past prior to a particular year.

The method may include calculating monthly predicted sales ratios of respective products to all predicted sales amounts of the plurality of products in the particular period by multiplying the monthly predicted sales ratios of the respective products in the particular period obtained from the first AI model by the monthly predicted sales ratio of the plurality of products obtained from the second AI model.

The first model comprises a model based on a convolution neural network (CNN), and the second model comprises a model based on a recurrent neural network (RNN).

According to an aspect of an example embodiment, a non-transitory computer-readable medium may store instructions, the instructions comprising: one or more instructions that, when executed by one or more processors of an electronic device, cause the one or more processors to: obtain first data indicating first ratios of monthly predicted sales of respective products of a plurality of products to monthly predicted sales amounts of the plurality of products within a particular period after a current time point by inputting data indicating a monthly sales ratio of each of the plurality of products obtained during a predetermined period before the current time point into a first artificial intelligence (AI) model, obtain second data indicating second ratios of monthly predicted sales of the plurality of products to all predicted sales amounts of the plurality of products within the particular period after the current time point by inputting data indicating monthly sales amounts of the plurality of products during a predetermined period before the current time point into a second AI model, and calculate monthly predicted sales ratios of the respective products to the all predicted sales amounts of the plurality of products in the particular period based on the first data and the second data. The first AI model comprises a neural network model that is different from the second AI model.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an electronic device according to an embodiment;

FIG. 2 is a block diagram illustrating an electronic device according to an embodiment;

FIG. 3A is a diagram illustrating learning data of a first AI model;

FIG. 3B is a diagram illustrating learning data of a first AI model;

FIG. 4A is a diagram illustrating learning data of a second AI model;

FIG. 4B is a diagram illustrating learning data of a second AI model;

FIG. 5 is a diagram illustrating an electronic device according to an embodiment;

FIG. 6 is a diagram illustrating data obtained from a trained first AI model;

FIG. 7 is a diagram illustrating data obtained from a trained second AI model;

FIG. 8 is a diagram illustrating data generated based on data obtained from the trained first and second AI models;

FIG. 9 is a diagram illustrating an electronic device according to an embodiment;

FIG. 10 is a block diagram illustrating an electronic device for training and using the AI model;

FIG. 11 is a block diagram illustrating a learning unit and an analysis unit according to an embodiment;

FIG. 12 is a block diagram illustrating a learning unit and an analysis unit according to an embodiment; and

FIG. 13 is a flowchart illustrating a control method of an electronic device according to an embodiment.

### DETAILED DESCRIPTION

Before describing the disclosure in detail, an overview for understanding the disclosure and drawings will be provided.

The terms used in the present specification and the claims are general terms identified in consideration of the functions of the various embodiments of the disclosure. However, these terms may vary depending on intent, technical interpretation, emergence of new technologies, and the like, of those skilled in the related art. Some terms may be selected by an applicant arbitrarily, and the meaning thereof will be described in the detailed description. Unless there is a specific definition of a term, the term may be construed based on the overall contents and technological understanding of those skilled in the related art.

The example embodiments of the present disclosure may be diversely modified. Accordingly, specific exemplary embodiments are illustrated in the drawings and are described in detail in the detailed description. However, it is to be understood that the present disclosure is not limited to a specific example embodiment, but includes all modifications, equivalents, and substitutions without departing from the scope and spirit of the present disclosure. Also, well-known functions or constructions are not described in detail since they would obscure the disclosure with unnecessary detail.

As used herein, the terms “first,” “second,” or the like, may identify corresponding components, and are used to distinguish a component from another without limiting the components.

A singular expression includes a plural expression, unless otherwise specified. It is to be understood that the terms such as “comprise” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term such as “module,” “unit,” “part,” etc., may refer, for example, to an element that performs at least one function or operation, and such element may be implemented as hardware or software, or a combination of hardware and software. Further, except for when each of a plurality of “modules,” “units,” “parts,” and the like, are realized in an individual hardware, the components may be integrated in at least one module or chip and be realized in at least one processor.

In the disclosure, “at least one of a, b, or c” may represent only a, only b, only c, both a and b, both a and c, both b and c, all of a, b, and c, and modifications thereof.

Hereinafter, non-limiting example embodiments of the disclosure will be described in detail with reference to the accompanying drawings so that those skilled in the art to which the disclosure pertains may easily practice the disclosure. However, the disclosure may be implemented in various different forms and is not limited to embodiments described herein. In addition, in the drawings, portions unrelated to the description will be omitted, and similar portions will be denoted by similar reference numerals throughout the specification.

An electronic device for predicting sales ratio of a plurality of products according to various embodiments will be described.

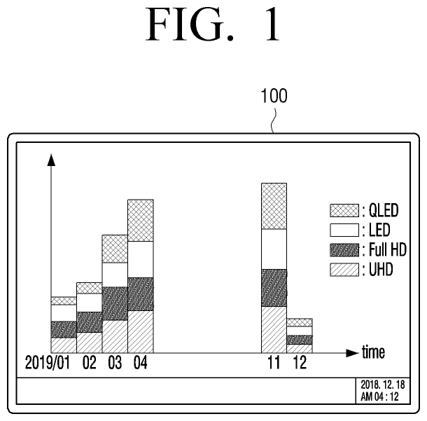

FIG. 1 is a diagram illustrating an electronic device according to an embodiment.

As shown in FIG. 1, an electronic device 100 may calculate a monthly predicted sales ratio of a plurality of products within a particular period after a current time point by using an AI model. The electronic device 100 may include a display for displaying the calculated sales ratio.

The plurality of products may refer to a product sold by a user or a product a user wishes to sell, and may be divided into different products depending on a specification such as a product size, shape, color, etc., or an identification number of the product. For example, when a user sells a television (TV), even for the same TV, a high definition (HD) TV, an ultra-high definition (UHD) TV, a full HD TV, a light emitting diode (LED) TV, a quantum dot light emitting diode (QLED) TV may be divided into different products. Also, even the same HD TV may be divided into different products such as HD 32, HD 43, HD 55, according to the size of the display.

The electronic device 100 may predict the monthly sales ratio of respective products for the monthly predicted sales of the plurality of products during the particular period after the current time point by using an AI model trained to predict the monthly sales ratio of respective products with respect to the monthly predicted sales of the plurality of products based on data related to monthly sales ratios of the plurality of products.

For example, the electronic device 100, by using the AI model trained to predict monthly sales ratio of respective products with respect to the monthly predicted sales of a plurality of products, when the sales amount of the plurality of TV products predicted in February 2019, which is the time after the current point time, is 1, may determine the monthly sales ratio of respective products such as the predicted sales amount of February 2019 of HD 32 indicating HD TV in 32 inches as 0.02, the predicted sales amount of February 2019 of HD 43 indicating HD TV in 43 inches as 0.03, the predicted sales amount of February 2019 of LED 55 which is the LED TV in 55 inches as 0.3, or the like.

The electronic device 100 may predict a monthly sales ratio of a plurality of products for a total amount of sales of a plurality of products during a particular period after the current time point, by using an AI model trained to predict a monthly sales ratio of a plurality of products with respect to the total sales amount of the plurality of products. For example, if the amount of sales of a plurality of TV products to be sold by the user in January, 2019 is expected to be one million, and the total sales amount of the TV in 2019 is expected to be ten million, the electronic device 100 may calculate the sales ratio of the plurality of TV products in January to 100/1000=0.1.

The electronic device 100 may calculate a monthly predicted sales ratio of respective products to all predicted sales amounts of a plurality of products in a particular period, based on the monthly predicted sales ratio of respective products for a monthly predicted sales of a plurality of products in the particular period and a monthly predicted sales ratio of the plurality of products for the all predicted sales amount of the plurality of products within a particular period predicted using the trained AI models. The monthly predicted sales ratio of respective products to all predicted sales amount of a plurality of products in the particular period may refer to the monthly predicted sales of respective products, if all predicted sales amounts of the plurality of products in the particular period is indicated as 1.

For example, the predicted sales ratio of LED 55 in January, 2019 to the predicted sales amount of the plurality of products in January, 2019 may be 0.02, and the sales ratio of a plurality of products in January to all predicted sales amount of the plurality of products from January to December of 2019 may be 0.2. In this example, when the all sales amount of a plurality of products from January to December 2019 is 1, the electronic device 100 may calculate a sales ratio of LED 55 in January, 2019 as 0.02×0.2=0.004.

As shown in FIG. 1, the electronic device 100 may represent a ratio of a monthly predicted sales of respective products to all predicted sales amounts of a plurality of products in the calculated particular period in a graph format. The electronic device 100 may display different identification marks for different products, thereby enabling a user to easily determine a monthly predicted sales ratio of respective products by products.

Referring to FIG. 1, a monthly predicted sales ratio of respective products to all predicted sales amount of a plurality of products within a particular period is displayed in the form of a bar graph, but is not limited thereto. The monthly predicted sales ratio of respective products to all predicted sales amount of the plurality of products in the particular period may be illustrated in various forms, such as a table, a pie graph, or the like.

The electronic device 100 may be all the products capable of calculating monthly predicted sales ratio of respective products with respect to all predicted sales amounts of a plurality of products using the trained AI model. The electronic device 100 according to various embodiments may include at least one of, for example, a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a medical device, a camera, or a wearable device. According to various embodiments, a wearable device may include at least one of an accessory type (e.g., a watch, a ring, a bracelet, an ankle bracelet, a necklace, a pair of glasses, a contact lens or a head-mounted-device (HMD)); a fabric or a garment-embedded type (e.g., electronic cloth); skin-attached type (e.g., a skin pad or a tattoo); or a bio-implantable circuit (e.g., implantable circuit).

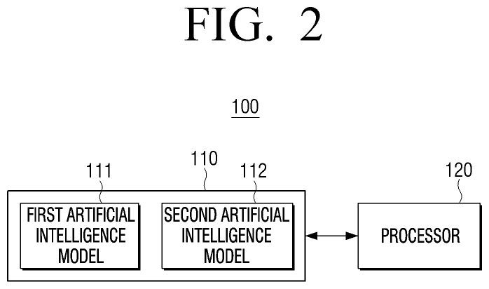

The electronic device 100 according to various embodiments may calculate a monthly predicted sales ratio of respective products to all predicted sales amounts of a plurality of products within a particular period after a current time point by using a trained AI model. Hereinafter, the electronic device 100 according to an embodiment will be described with reference to FIG. 2.

FIG. 2 is a block diagram illustrating an electronic device according to an embodiment.

Referring to FIG. 2, the electronic device 100 may include a memory 110 and a processor 120.

The memory 110 may include, for example, an internal memory or an external memory. The internal memory may include, for example, at least one of a volatile memory such as a dynamic random access memory (DRAM), a static random access memory (SRAM), a synchronous dynamic random access memory (SDRAM), or a non-volatile memory, such as one time programmable ROM (OTPROM), programmable ROM (PROM), erasable and programmable ROM (EPROM), electrically erasable and programmable ROM (EEPROM), mask ROM, flash ROM, a flash memory, such as NAND flash or NOR flash), a hard disk drive (HDD) or a solid state drive (SSD).

In the case of the external memory, the memory may be implemented as a flash drive, for example, a compact flash (CF), secure digital (SD), micro secure digital (micro-SD), mini secure digital (mini-SD), extreme digital (xD), or multi-media card (MMC), a memory stick, or the like. The external memory may be connected to the electronic device 100 functionally and/or physically through various interface.

The memory 110 is accessed by the processor 120 and reading/writing/modifying/deleting/updating of data by the processor 120 may be performed. In the disclosure, the term memory may include the memory 110, read-only memory (ROM) in the processor 120, RAM, or a memory card (for example, a micro secure digital (SD) card, and a memory stick) mounted to the electronic device 100.

The memory 110 may store the first AI model and the second AI model.

The AI model described herein may be a determination model trained based on an AI algorithm and may be a model based on, for example, a neural network. The trained AI model may be designed to simulate a human brain structure on a computer, and may include a plurality of network nodes simulating a neuron of a human neural network and having a weight. The plurality of network nodes may each establish a connection relation so that the neurons simulate synaptic activity of transmitting and receiving signals through synapses. For example, the trained AI model may include a neural network model or a deep learning model developed from a neural network model. In the deep learning model, a plurality of network nodes is located at different depths (or layers) and may exchange data according to a convolution connection.

A first AI model 111, among AI models stored in the memory 110, may be a model trained based on data indicating sales ratios of respective products in a specific month of the past.

The first AI model 111 may be trained by using data related to sales ratios of respective products in a specific month in the past and sales ratios of respective products of the past before then.

The first AI model 111 may be a model trained to predict monthly sales ratios of respective products in a particular period based on data indicative of sales ratios of respective products for sales amounts of a plurality of products in a particular month and data associated with monthly sales ratios of respective products for monthly sales amounts of the plurality of products for a past predetermined period prior to a particular month.

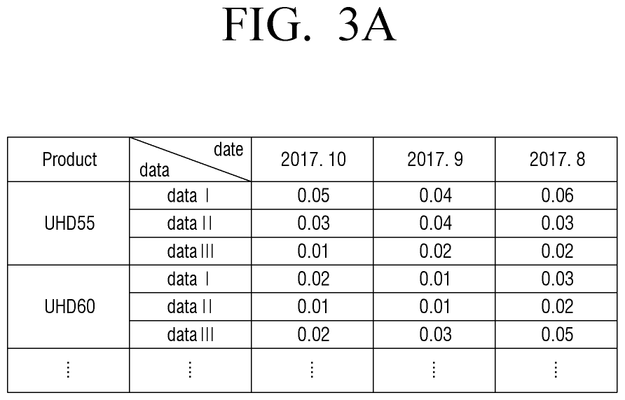

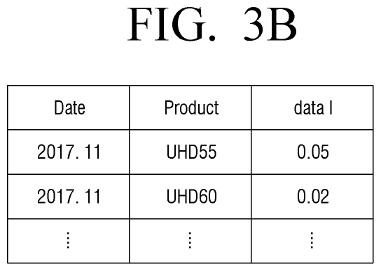

FIGS. 3A and 3B are diagrams illustrating learning data of a first AI model according to an embodiment.

FIG. 3A illustrates data related to monthly sales ratios of respective products to monthly sales of a plurality of products for a predetermined period in the past prior to a particular month, and illustrates learning data input to the first AI model 111 to train the first AI model 111, and FIG. 3B illustrates the sales ratios of respective products related to the sales amounts of a plurality of products in a particular month, and may illustrate data output as a result of training the first AI model 111 with the learning data of FIG. 3A.

Data I, II, and III in FIG. 3A may be data related to sales ratios of a plurality of products in the past.

Data I may represent sales ratio data of respective products for respective monthly sales amounts of a plurality of products sold by a seller (or a user), data II may represent monthly sales ratio data of respective products for monthly sales of a plurality of products sold by a seller (or a user) to a plurality of place of sales (e.g., a corporate distribution company), and data III may represent sales ratio data of respective products that the seller (or the user) expects to sell for each month to a plurality of sellers. However, this is merely an example, and is not limited thereto. That is, various data related to the sales ratio of the plurality of products may be used as learning data of the first AI model 11.

FIG. 3B may illustrate the monthly sales ratio data of respective products for the monthly sales of a plurality of products sold by a seller (or a user) of data I of FIG. 3A.

The first AI model 111 may be trained to predict the monthly sales ratio of respective products for respective monthly sales amounts of the plurality of products of FIG. 3B, based on data associated with the monthly sales ratio of respective products for a monthly sales amount of a plurality of products for August 2017, as shown in FIG. 3A. At this time, because the data of monthly sales ratios of respective products in November 2017 has already been present, the first AI model 111 may learn a correlation between data related to monthly sales ratios of respective products to monthly sales amounts of a plurality of products from August 2017 to October 2017, and data related to monthly sales ratios of respective products of November 2017.

Referring to FIG. 3A, only data of August to October 2017 is shown, but the embodiment is not limited thereto, and the first AI model 111 may use data prior to August 2017, or data after October 2017. The data related to monthly sales ratios of respective products in another period may be used as learning data of the first AI model 111, and data for a period less than or greater than three months may be used, instead of three months.

For example, the first AI model 111 may learn a correlation between monthly sales ratios of respective products for a plurality of TV sales amounts in October 2017 and monthly sales ratios of respective products for a plurality of TV sales amounts from July to September 2017, based on data associated with respective products (e.g., UHD 55, UHD 60, LED 65, LED 75, or the like) for a plurality of TV sales amounts from July to September 2017.

Similarly, the first AI model 111 may learn a correlation between the monthly sales ratios of respective products for a plurality of TV sales amounts of September 2017 and monthly sales ratios for respective products for a plurality of TV sales amounts of June to August 2017, based on the data associated with respective products (e.g., UHD 55, UHD 60, LED 65, LED 75, or the like) for a plurality of TV sales amounts from June to August 2017.

As described above, the first AI model 111 may be trained based on data related to monthly sales ratios of respective products to monthly sales amounts of a plurality of products prior to a particular month in the past, and data representing sales ratios of respective products to the amounts of sales of a plurality of products in the particular month in the past.

The second AI model 112 among the AI models stored in the memory 110 may be a model trained based on data indicating monthly sales amounts of a plurality of products in the past.

The second AI model 112 may be trained by using the monthly sales data of a plurality of products of a particular month in the past and monthly sales data of a plurality of products in the past before then.

The second AI model 112 may be a model trained to predict monthly sales ratios of a plurality of products within a particular period based on data indicative of monthly sales of a plurality of products in a particular year and data indicative of monthly sales amounts of the plurality of products for a predetermined period in the past prior to a particular year.

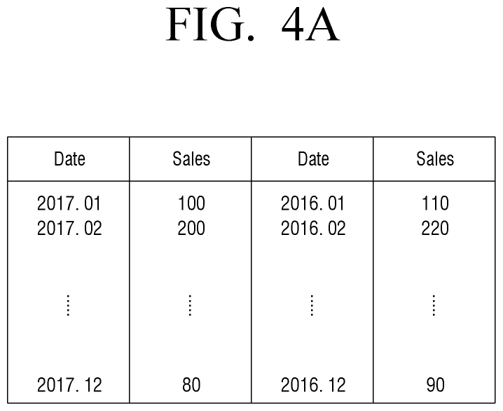

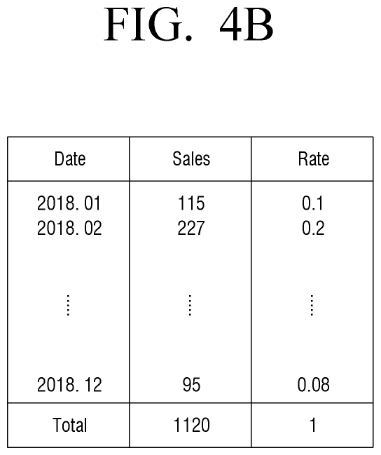

FIGS. 4A and 4B are diagrams illustrating learning data of a second AI model according to an embodiment.

FIG. 4A illustrates data representing monthly sales amounts of a plurality of products for a particular period prior to a particular year and illustrates the learning data input to the second AI model 112 for training the second AI model 112, and FIG. 4B illustrates data representing monthly sales amounts and monthly sales ratios of a plurality products in a particular period, and illustrates data output as a result of training of the second AI model 112 with the learning data as illustrated in FIG. 4A.

For example, the second AI model 112 may be trained to predict monthly sales ratios of a plurality of products from January to December, 2018 of FIG. 4B, based on data regarding the monthly sales amounts of the plurality of products of year 2016 and year 2017 in FIG. 4A. At this time, the period from January to December of 2018 may be the past based on the current time point. In other words, the second AI model 112 may learn a correlation between the data for monthly sales amounts of a plurality of products of 2016 and 2017 and data associated with respective monthly sales amounts of respective products from January to December 2018 in that data related to monthly sales and monthly sales ratios of respective products from January to December 2018 are already present.

While FIG. 4A shows only data about monthly sales amounts of a plurality of products of 2016 and 2017, the embodiment is not limited thereto, and the second AI model 112 may be trained using data prior to 2016 or after 2018. The learning data of the second AI model 112 may include data of two years and also data of a longer period.

For example, the second AI model 112 may be trained to predict the monthly sales amounts of a plurality of products of 2016 based on the data about monthly sales amounts of a plurality of products in 2014 and 2015.

The second AI model 112 may be trained based on the data indicative of monthly sales amounts of a plurality of products for a predetermined period in the past prior to a particular year and data indicative of monthly sales amounts of a plurality of products.

The first AI model may include a neural network model different from the second AI model. Specifically, the first AI model may include an AI model based on a convolutional neural network (CNN), and the second AI model may include an AI model based on a recurrent neural network (RNN). In particular, the second AI model may be used to obtain data that varies over time, such as monthly sales ratios of a plurality of products within a particular period, so that the second AI model may include an RNN-based AI model that processes data having temporal characteristics.

However, this is an example, and the first AI model may also be an AI model based on an RNN. The second AI model is not necessarily an AI model based on an RNN. The first AI model and the second AI model may be AI models based on various neural networks.

The memory 110 may store a plurality of learning data to train the first AI model 111 and the second AI model 112.

The processor 120 may control the overall operation of the electronic device 100. For example, the processor 120 may control a plurality of hardware or software components connected to the processor 120 by driving an operating system or an application program and may perform various data processing and operations. The processor 120 may be one or both of a central processing unit (CPU) or a graphics-processing unit (GPU). The processor 120 may be implemented as at least one general processor, a digital signal processor, an application specific integrated circuit (ASIC), a system on chip (SoC), a microcomputer (MICOM), or the like.

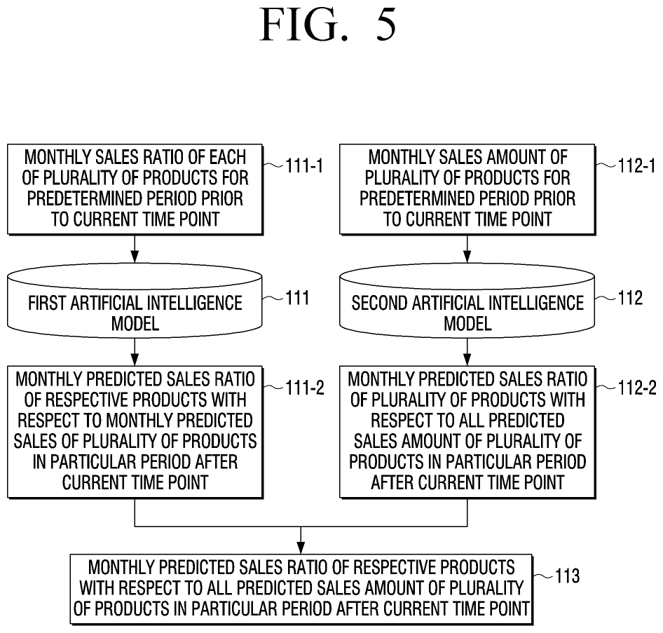

Referring to FIG. 5, with the data 111-1 related to respective monthly sales ratios of the plurality of products obtained for a predetermined period before the current time point as an input of the first AI model 111, the processor 120 may obtain data representing the monthly predicted sales ratios 111-2 of respective products with respect to the monthly predicted sales of a plurality of products in a particular period after the current time point.

Because the first AI model 111 is a model trained using sales ratio data of respective products of the past prior to the particular month in the past in order to obtain data related to the sales ratios of respective products in a particular month in the past, the processor 120 may input the data related to a monthly sales ratio of each of a plurality of products obtained for a predetermined time prior to the particular period or the current time point to the first AI model, to obtain data indicating monthly predicted sales ratios of respective products to the monthly predicted sales of a plurality of products in the particular period after the current time point.

The data related to the monthly sales ratio of each of the plurality of products may include data indicating at least one of the monthly sales ratios for respective products over a predetermined time, the percentage of sales of respective products sold monthly to the place of sales for a predetermined period, and the percentage of sales for respective products expected to be sold monthly at the vendor.

The monthly sales ratio data for respective products for a particular period may be, for example, the data corresponding to the data I of FIG. 3, the sales ratio data of respective products sold monthly to the vendor for a predetermined period may be, for example, the data corresponding to the data II as illustrated in FIG. 3, and the data indicating at least one of the sales ratios of respective products expected to be sold monthly at the vendor may be the data corresponding to data III.

For example, it may be assumed that December 2018 is the current time point. The processor 120 may input the data associated with a monthly sales ratio of each of a plurality of products obtained for a predetermined period prior to the current time point (i.e., data I, II, and III prior to the current time point) to the first AI model 111 to obtain monthly predicted sales ratios of respective products to a monthly predicted sales amount of a plurality of products of January 2019 which is after the current time point.

The processor 120 may obtain the monthly predicted sales ratios of respective products to the monthly predicted sales of a plurality of products in January 2019, which is after the current point of time, from the trained first AI model 111.

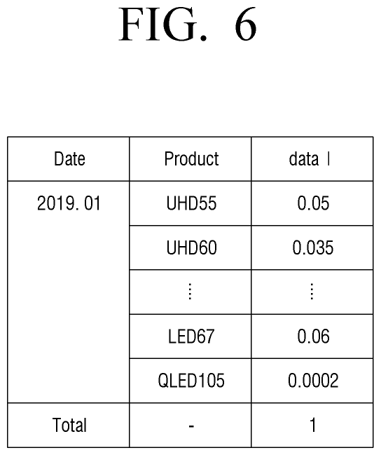

FIG. 6 illustrates monthly predicted sales ratio data of respective products related to the monthly predicted sales of a plurality of products in January 2019 obtained from the trained first AI model 111.

Referring to FIG. 6, the processor 120 may obtain, from the trained first AI model 111, data that the predicted sales ratio of UHD 55 in January 2019 is 0.05, the predicted sales ratio of UHD 60 in January 2019 is 0.035, the predicted sales ratio of LED 67 in January 2019 is 0.06, and the predicted sales ratio of QLED 105 in January 2019 is 0.0002. Here, the sum of the sales ratios of a plurality of products of January of 2019 may be 1.

Referring back to FIG. 5, the processor 120 may obtain data indicating the monthly predicted sales ratios of a plurality of products to all predicted sales amounts of a plurality of products in the particular period after the current time using a second AI model.

The processor 120 may obtain data representing monthly predicted sales of a plurality of products in a particular period after a current time point by inputting data representing monthly sales amounts of a plurality of products for a predetermined period of time before a current time point, and calculate data representing monthly predicted ratios of a plurality of products for all of the plurality of products in a particular period through the obtained data.

For example, the current point of time may be December 2018. The processor 120 may input data indicating the monthly sales of a plurality of products during a predetermined period (e.g., January to December 2017, January to December 2016) prior to the current time to the second AI model 112.

The processor 120 may obtain, from the trained second AI model 112, data representing monthly predicted sales ratios of a plurality of products to all predicted sales amounts of a plurality of products from January to December of 2019 which is after the current time point.

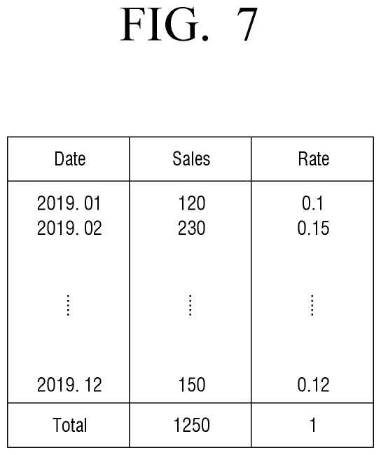

Referring to FIG. 7, there is shown data representing the monthly predicted sales of a plurality of products, all predicted sales amounts of the plurality of products, and monthly predicted sales ratios of the plurality of products for the all predicted sales amounts of the plurality of products, from January to December 2019, obtained from the trained second AI model 112 by the processor 120.

The processor 120 may obtain the monthly predicted sales ratio of a plurality of products from January to December 2019 from the second AI model 112 as illustrated in FIG. 4.

As described above in FIG. 4, the trained second AI model 112 may obtain monthly predicted sales of a plurality of products from January to December 2019 based on the monthly predicted sales data of the plurality of products prior to 2019, and calculate the all predicted sales amounts of 2019 based on the obtained monthly predicted sales. The processor 120 may obtain data indicative of monthly predicted sales ratios of respective products for monthly predicted sales of the plurality of products in 2019 from the second AI model 112.

In the above-described example, a particular period and a predetermined period are described as January to December of a particular year, but it is not necessarily limited thereto. For example, the processor 120 may obtain data indicative of monthly predicted sales ratios of respective products for the monthly predicted sales of a plurality of products from March 2019 to February 2020 from the second AI model 112.

Referring back to FIG. 5, the processor 120 may calculate monthly predicted sales ratios of respective products to all predicted sales amounts of a plurality of products in a particular period based on data representing monthly predicted sales ratios of respective products for monthly predicted sales of a plurality of products within a particular period after the current time obtained from the first model and data representing monthly predicted sales ratios of a plurality of products to all predicted sales amounts of the plurality of products within a particular period after the current time obtained from the second model.

Specifically, the processor 120 may multiply monthly predicted sales ratios of respective products in a particular period obtained from the first AI model 111 by monthly predicted sales ratios of a plurality of products obtained from a second AI model, to calculate monthly predicted sales ratios of respective products to all predicted sales amounts of a plurality of products in a particular period.

Because the monthly predicted sales ratios of respective products in a particular period to the monthly predicted sales of the plurality of products obtained from the first AI model 111 are ratio values obtained based on monthly predicted sales of a plurality of products, the ratio of the monthly predicted sales of a plurality of products may be considered 1. Because the monthly predicted sales ratios of the plurality of products to all predicted sales amounts of the plurality of products may be output from the second AI model 112, the processor 120 may multiply the data obtained from the first AI model 111 by the data obtained from the second AI model 112 to obtain the monthly predicted sales ratios of respective products to the all predicted sales amounts of the plurality of products in the entire particular period.

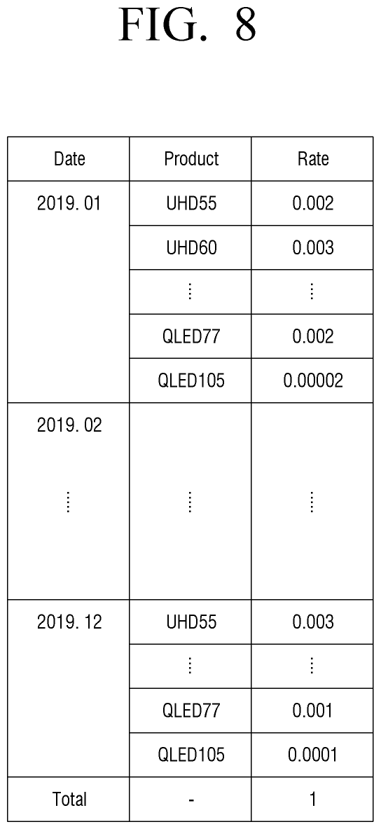

FIG. 8 illustrates the monthly predicted sales ratios of respective products to all predicted sales amounts of a plurality of products in a particular period obtained according to an embodiment.

For example, as shown in FIG. 8, the processor 120 may calculate the monthly predicted sales ratios of respective products to all predicted sales amounts of a plurality of products from January to December 2019. Because the processor 120 calculates the ratios based on the all predicted sales amounts of the plurality of products from January to December 2019, the sum of the monthly predicted sales ratios of respective products from January to December may be 1.

Referring to FIG. 8, the sum of the predicted sales ratios of each of a plurality of products belonging to each month of 2019 may be the same value as the monthly predicted sales ratios of the plurality of products to all predicted sales amounts of the plurality of products obtained by the second AI model. For example, the sum of the ratio of UHD 55 which is 0.002, the ratio of UHD 60 which is 0.003, . . . , the ratio of QLED 77 which is 0.002, and the ratio of QLED 105 which is 0.00002 as in FIG. 8 may be equal to 0.1 of the predicted sales ratios of January of 2019 obtained in FIG. 7.

According to an embodiment, the processor 120 may obtain, from the data related to sales, data 111-1 of respective products during a predetermined period prior to the current time point which is the input data of the first AI model 111 and data 112-1 of monthly sales amount of a plurality of products for a predetermined period prior to the current time point which is the input data of the second AI model 112.

The data related to sales may include various data such as past sales amount data, third party data including sales amount prediction data, macroeconomic data, marketing/strategy activities data, pricing plans data, or the like.

The data related to the sales may be data stored in the memory 110 of the electronic device 100, or the data received by the electronic device 100 from another electronic device through a communication interface.

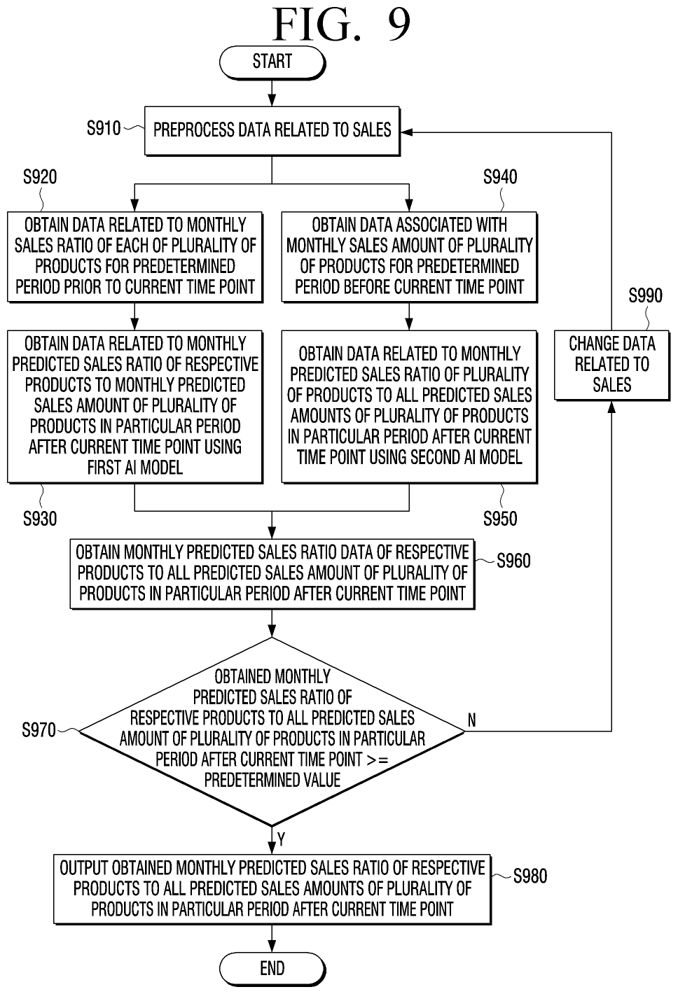

FIG. 9 is a diagram illustrating an electronic device according to an embodiment.

The processor 120 may preprocess data related to sales in operation S910. The processor 120 may preprocess data related to sales using a preprocessing module.

The processor 120 may perform data cleaning, data integration, data reduction, and data transformation on data related to sales by using a preprocessing module to preprocess data related to sales. The data preprocessing technique, such as data cleaning, data integration, data reduction, and data transformation, is well known in the art, and a detailed description thereof will be omitted.

The processor 120 may use the preprocessing module to obtain information about variables such as a product name, identification number, size, color, sales amount, sales period, sales event, or the like, from the data related to sales, and may obtain information about variables used for the data 111-1 of each of a plurality of products during a predetermined period prior to the current time point and monthly sales amount data 112-1 of a plurality of products for a predetermined period prior to the current time point and information about the variables, by performing data cleaning, data integration, data reduction, data transformation, or the like, for the obtained information about the variables. The processor 120, based on the obtained variables and information about the variables, may obtain the data 111-1 of each of the plurality of products for a predetermined period prior to the current time point and the monthly sales data 112-1 of a plurality of products for a predetermined period prior to the current time point in operations S920 and S940.

The processor 120 may obtain the data related to the monthly predicted sales ratios of respective products for the monthly predicted sales of the plurality of products in a particular period after the current time point, with the obtained data 111-1 of each of the plurality of products during a predetermined period prior to the current time point as the input of the first artificial intelligence model in operation S930.

The processor 120 may obtain the data related to the monthly predicted sales ratios of the plurality of products for the all predicted sales amounts of the plurality of products in a particular period after the current time point, with the monthly sales data 112-1 of a plurality of products during a predetermined period prior to the current time point as the input of the second AI model in operation S950.

The processor 120, by using the data obtained in operations S930 and S950, may obtain monthly predicted sales ratio data of respective products to all predicted sales amounts of the plurality of products in a particular period after the current time point in operation S960.

The description of the obtained data in operations S930, S950, and S960 is substantially the same as that described with respect to FIG. 5 to FIG. 8 and thus detailed description will be omitted to avoid redundancy.

The processor 120 may compare the monthly predicted sales ratio data of respective products with respect to all predicted sales amounts of a plurality of products in a particular period after the current time point obtained from the operation S960 with a predetermined value in operation S970. The predetermined value may be monthly predicted sales ratios of respective products inputted by the user.

The processor 120 may compare the monthly predicted sales ratio data of respective products with respect to all predicted sales amounts of a plurality of products in a particular period after the current time point obtained from the operation S960 with a predetermined value in operation S970. The predetermined value may be a value set by a user, and may be monthly predicted sales ratios of respective products to all predicted sales amounts of a plurality of products during a particular period, which the user wants to sell during a particular period after the current time point.

The processor 120 may output monthly predicted sales ratio data of respective products to all predicted sales amounts of a plurality of products in a particular period after the current time point, if the monthly predicted sales ratio data of respective products to all predicted sales amounts of a plurality of products in a particular period after the current time point obtained in operation S960 is greater than or equal to a predetermined value in operation S980.

If the monthly predicted sales ratio data of respective products for all predicted sales amounts of the plurality of products in the particular period after the current time point obtained in operation S960 is equal to or less than a predetermined value, the processor 120 may change the data related to the sales in operation S990.

The processor 120 may add the data which is stored in the memory 110 but is not used in the preprocessing process as the data related to sales or additionally obtain data related to sales from an external source.

For example, it may be assumed that a predetermined value is set by reflecting a situation in which a sports event, such as the Olympics, is scheduled within a particular period after a current time point and the sales of the TV are expected to increase in a particular month.

In this example, if the first artificial intelligence model 111 and the second artificial intelligence model 112 of the electronic device 100 are trained without considering that the sports event is held, that is, if the models are not trained based on the monthly sales ratio data of a plurality of products when there is a sports event and monthly sales data of a plurality of products when there is a sports event, the processor 120 may calculate the monthly predicted sales ratio of respective products to all predicted sales amount of the plurality of products in a particular period after the current time point without considering the sports event. The calculated predicted sales ratio value does not consider the sports event and may be smaller than the predetermined value set by the user.

For example, the user of the electronic device 100 may take into account that sport events will be held in August, determine that predicted sales ratios of respective products in May, June, July of all predicted sales amounts of a plurality of products in a particular period will increase compared to the last year, and may set a predetermined value, but the processor 120 may determine that the predicted sales ratio of respective products in May, June, July to all predicted sales amounts of a plurality of products in a particular period would be similar to the last year based on the first AI model 111 and the second AI model 112 that are trained based on overseas data where sport events do not exist, and the determined value may be smaller than the predetermined value.

In this example, the processor 120 may change the data related to the sales. The processor 120 may obtain data related to the monthly sales of a plurality of products for a predetermined period prior to the current point in operation S920 and the data associated with the monthly sales ratio of each of the plurality of products for a predetermined period before the current time point of the operation S940 by preprocessing the data associated with the changed sales, and based thereon, the processor 120 may re-train the first AI model 111 and the second AI model 112.

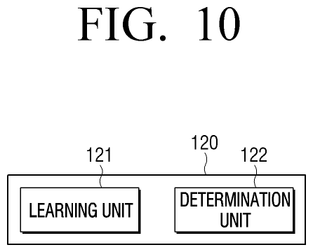

The processor 120 may add data of the year of the sport event at the similar period to preprocess the data related to the sale, and by re-training the first AI model 111 and the second AI model 112, the processor 120 may enable the result to reflect that the monthly predicted sales ratio of each product to all predicted sales amounts of a plurality of products in the particular period after the current time point obtained in operation S960 may be a result that reflects the situation after the current time point in which there is the sport event. FIG. 10 is a block diagram illustrating the electronic device for learning and using the AI model.

The processor 120 may include at least one of a learning unit 121 and a determination unit 122.

The learning unit 121 may generate, train, or re-train the first AI model to obtain data indicative of monthly sales ratios of respective products related to the monthly predicted sales of the plurality of products in a particular period using the learning data.

The learning unit 121 may generate, train, or re-train the second AI model to obtain data indicative of monthly sales ratios of respective products related to the monthly predicted sales amounts of the plurality of products in a particular period using the learning data.

The determination unit 122 may use at least one data related to a product sales ratio as input data of the trained first AI model to generate data representing a monthly sales ratio of each product for a plurality of products in a particular period. In another embodiment, the determination unit 122 may use at least one data related to the amount of sales of the product as input data of a trained second AI model to generate data representing a monthly predicted sales ratio of a plurality of products for all of the plurality of products in a particular period.

At least a portion of the learning unit 121 and at least a portion of the determination unit 122 may be implemented as software modules or at least one hardware chip form and mounted in the electronic device 100. For example, at least one of the learning unit 121 and the determination unit 122 may be manufactured in the form of an exclusive-use hardware chip for AI, or a conventional general purpose processor (e.g., a CPU or an application processor) or a graphics-only processor (e.g., a GPU) and may be mounted on various electronic devices as described above. Herein, the exclusive-use hardware chip for AI is a dedicated processor for probability calculation, and it has higher parallel processing performance than an existing general purpose processor, so it can quickly process computation tasks in AI such as machine learning. When the learning unit 121 and the determination unit 122 are implemented as a software module (or a program module including an instruction), the software module may be stored in a non-transitory computer-readable medium. In this case, the software module may be provided by an operating system (OS) or by a predetermined application. Alternatively, some of the software modules may be provided by an O/S, and some of the software modules may be provided by a predetermined application.

The learning unit 121 and the determination unit 122 may be mounted on one electronic device, or may be mounted on separate electronic devices, respectively. In addition, the learning unit 121 and the determination unit 122 may provide the model information constructed by the learning unit 121 to the determination unit 122 via wired or wireless communication, and provide data which is input to the determination unit 122 to the learning unit 121 as additional data.

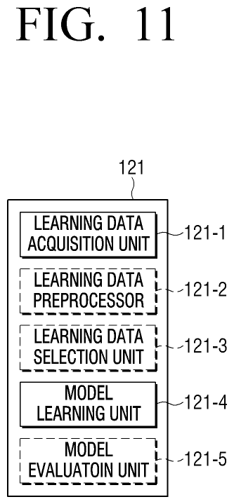

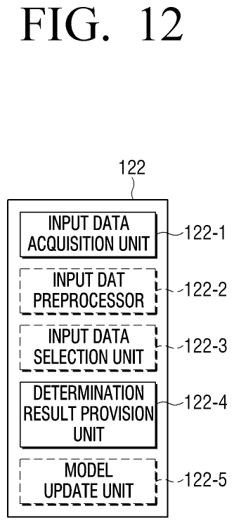

FIGS. 11 and 12 are block diagrams illustrating the learning unit 121 and the determination unit 122 according to an embodiment.

Referring to FIG. 11, the learning unit 121 may include a learning data acquisition unit 121-1 and a model learning unit 121-4. The learning unit 121 may further selectively implement at least one of a learning data preprocessor 121-2, a learning data selection unit 121-3, and a model evaluation unit 121-5.

The learning data acquisition unit 121-1 may obtain learning data for a first AI model for obtaining a monthly predicted sales ratio of each product for a plurality of products of a plurality of products within a particular period. In this example, the learning data of the first AI model 111 may be data related to each monthly sales ratio of the plurality of products obtained for a predetermined period before the current time point. For example, the learning data of the first AI model 111 may be at least one of monthly sales ratios of respective products for a predetermined period, sales ratios of respective products sold to the vendor for a predetermined period, and sales ratios of respective products that are expected to be sold for each month by the vendor.

The learning data acquisition unit 121-1 may obtain data related to the amount of sales of the plurality of products during a particular period before the current time point in order to train the second AI model 112. Specifically, the learning data acquisition unit 121-1 may obtain data representing a monthly sales amount of a plurality of products in a particular year and data representing a monthly sales amount of a plurality of products during a past predetermined period before a particular year, as learning data of a second AI model.

The model learning unit 121-4 may use the learning data to train the first AI model 111 to have a reference to generate data representing monthly predicted sales ratios of respective products in a particular period after the current time point.

The model learning unit 121-4 may use the learning data to train the second AI model 112 to have a reference to generate data representing monthly predicted sales ratios of a plurality of products in a particular period after the current time point.

The model learning unit 121-4 may train an AI model through supervised learning. Alternatively, the model learning unit 121-4 may train, for example, by itself using learning data without specific guidance to make the AI model learn through unsupervised learning.

The model learning unit 121-4 may train the AI model through reinforcement learning using, for example, feedback on whether the result of the determination according to learning is correct. The model learning unit 121-4 may also make an AI model learn using, for example, a learning algorithm including an error back-propagation method or a gradient descent.

In addition, the model learning unit 121-4 may learn a selection criterion about which learning data should be used.

The model learning unit 121-4 may determine an AI model having a great relevance between the input learning data and the basic learning data as an AI model to be trained when there are a plurality of AI models previously constructed. In this case, the basic learning data may be pre-classified according to the type of data, and the AI model may be pre-constructed for each type of data. For example, the basic learning data may be pre-classified based on various criteria such as the area where the learning data is generated, the time at which the learning data is generated, the size of the learning data, the genre of the learning data, the creator of the learning data, the type of the object in the learning data, or the like.

When the AI model is trained, the model learning unit 121-4 may store the trained AI model. In this case, the model learning unit 121-4 may store the trained AI model in the memory 110 of the electronic device 100.

The learning unit 121 may further implement a learning data preprocessor 121-2 and a learning data selection unit 121-3 to improve the determination result of the AI model or to save resources or time required for generation of the AI model.

The learning data preprocessor 121-2 may preprocess obtained data so that the obtained data may be used in the learning of the first AI model 111 and the second AI model 112.

The learning data selection unit 121-3 may select data required for learning from the data obtained by the learning data acquisition unit 121-1 or the data preprocessed by the learning data preprocessor 121-2. The selected learning data may be provided to the model learning unit 121-4.

The learning data selection unit 121-3 may select learning data for learning from the obtained or preprocessed data in accordance with a predetermined selection criterion. The learning data selection unit 121-3 may also select learning data according to a predetermined selection criterion by learning by the model learning unit 121-4.

The learning unit 121 may further implement the model evaluation unit 121-5 to improve a determination result of the AI model.

The model evaluation unit 121-5 may input evaluation data to the AI model, and if the determination result which is output from the evaluation result does not satisfy a predetermined criterion, the model evaluation unit 121-5 may make the model learning unit 121-4 learn again.

For example, if the number or ratio of the evaluation data, of which determination result is not accurate, exceeds a preset threshold, among the result of the determination of the trained AI model with respect to the evaluation data, the model evaluation unit 121-5 may evaluate that a predetermined criterion is not satisfied.

When there are a plurality of trained AI models, the model evaluation unit 121-5 may evaluate whether each trained AI model satisfies a predetermined criterion, and determine the model which satisfies a predetermined criterion as a final AI model. Here, when there are a plurality of models that satisfy a predetermined criterion, the model evaluation unit 121-5 may determine one or a predetermined number of models which are set in an order of higher evaluation score as a final AI model.

Referring to FIG. 12, the determination unit 122 according to some embodiments may implement an input data acquisition unit 122-1 and a determination result provision unit 122-4.

In addition, the determination unit 122 may further implement at least one of an input data preprocessor 122-2, an input data selection unit 122-3, and a model update unit 122-5 in a selective manner.

The input data acquisition unit 122-1 may obtain data to obtain data representing the monthly predicted sales ratio of each product for a plurality of products in a particular period after the current time point. The input data acquisition unit 122-1 may obtain data related to each monthly sales ratio of the plurality of products obtained for a predetermined period before the current time point.

The input data acquisition unit 122-1 may obtain data to obtain data indicative of a monthly predicted sales ratio of a plurality of products to all predicted sales objects in a particular period after the current time point. That is, the input data acquisition unit 122-1 may obtain data representing the monthly sales volume of the plurality of products for a predetermined period before the current time point.

The determination result providing unit 122-4 may apply the input data obtained from the input data acquisition unit 122-1 to the first AI model 111 as the input value, and may determine the monthly predicted sales ratios of respective products for the monthly predicted sales of a plurality of products in a particular period after the current time point.

The determination result providing unit 122-4 may apply the input data obtained from the input data acquisition unit 122-1 to the trained second AI model 112 as an input value to determine monthly predicted sales ratios of a plurality of products to all predicted sales amounts of a plurality of products within a particular period after the current time point.

The determination unit 122 may further implement the input data preprocessor 122-2 and the input data selection unit 122-3 in order to improve a determination result of the AI model or save resources or time to provide the determination result.

The input data preprocessor 122-2 may preprocess the obtained data so that the data obtained by the input data acquisition unit 122-1 may be used. The input data preprocessor 122-2 may process the obtained data into the pre-defined format to use the obtained data so as to obtain an image of an object without a fault. Alternatively, the input data preprocessor 122-2 may preprocess the obtained data so that the obtained data is used to determine whether there is a defect in an object and a type of the defect.

The input data selection unit 122-3 may select data for providing a response from the data obtained by the input data acquisition unit 122-1 or the data preprocessed by the input data preprocessor 122-2. The selected data may be provided to the determination result provision unit 122-4. The input data selection unit 122-3 may select some or all of the obtained or preprocessed data according to a predetermined selection criterion for providing a response. The input data selection unit 122-3 may also select data according to a predetermined selection criterion by learning by the model learning unit 121-4.

The model update unit 122-5 may control the updating of the AI model based on the evaluation of the determination result provided by the determination result provision unit 122-4. For example, the model update unit 122-5 may provide the determination result provided by the determination result provision unit 122-4 to the model learning unit 121-4 so that the model learning unit 121-4 may ask for further learning or updating the AI model. The model update unit 122-5 may retrain the AI model based on the feedback information according to a user input.

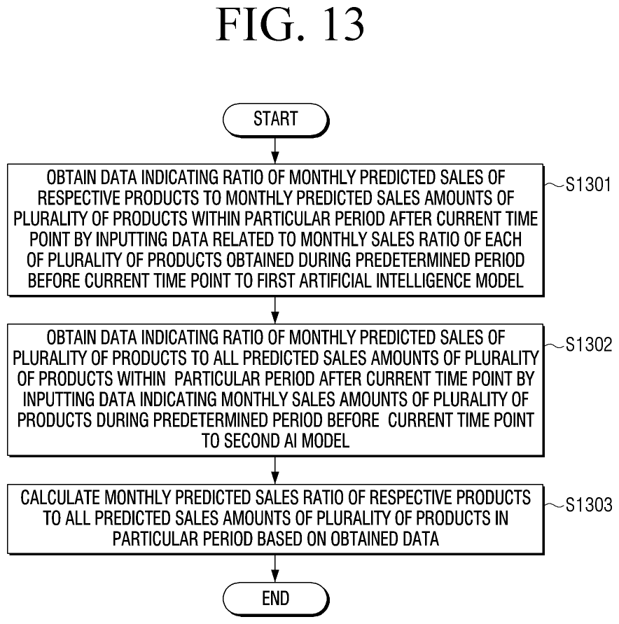

FIG. 13 is a flowchart illustrating a control method of an electronic device according to an embodiment.

The method may include obtaining data indicating ratios of monthly predicted sales of respective products to monthly predicted sales amounts of a plurality of products within a particular period after a current time point by inputting data indicating a monthly sales ratio of each of a plurality of products obtained during a predetermined period before the current time point to the first artificial intelligence model in operation S1301.

The first AI model may be a model trained to predict the monthly sales ratios of respective products within the particular period based on data related to sales ratios of the respective products to the sales amounts of the plurality of products in a particular month and data related to monthly sales ratios of the respective products to the monthly sales amounts of the plurality of products during a predetermined period in the past prior to the particular month.

The data related to the monthly sales ratio of each of the plurality of products may include data indicating at least one of monthly sales ratios of respective products during the predetermined period, sales ratios of the respective products sold on a monthly basis to a place of sales during the predetermined period, and sales ratios of the respective products expected to be sold on a monthly basis by the place of sales.

The method may include obtaining data indicating ratios of monthly predicted sales of the plurality of products to all predicted sales amounts of the plurality of products within a particular period after the current time point by inputting data indicating monthly sales amounts of the plurality of products during a predetermined period before the current time point to a second AI model in operation S1302.

The second AI model may be trained to predict the monthly sales ratios of the plurality of products within the particular period based on the data indicating the monthly sales amounts of the plurality of products during the predetermined period in the past prior to a particular year.

The first model may include a model based on a convolution neural network (CNN), and the second model may include a model based on a recurrent neural network (RNN).

The method may include calculating monthly predicted sales ratios of the respective products to the all predicted sales amounts of the plurality of products in the particular period based on the obtained data in operation S1303.

The monthly predicted sales ratios of respective products to all predicted sales amounts of the plurality of products in the particular period may be calculated by multiplying the monthly predicted sales ratios of the respective products in the particular period obtained from the first AI model by the monthly predicted sales ratios of the plurality of products obtained from the second AI model.

The calculated value may be displayed on a display. The calculated value may be represented in various forms such as a graph, a table, a figure, or the like.

The various embodiments described above may be implemented with software, hardware, or the combination of software and hardware. By hardware implementation, the embodiments of the disclosure may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electric units for performing other functions. According to a software implementation, embodiments such as the procedures and functions described herein may be implemented with separate software modules. Each of the above-described software modules may perform one or more of the functions and operations described herein.

Various embodiments may be implemented as software that includes instructions stored in machine-readable storage media readable by a machine (e.g., a computer). A device may call instructions from a storage medium and operate in accordance with the called instructions, including an electronic device (e.g., electronic device 100). When the instruction is executed by a processor, the processor may perform the function corresponding to the instruction, either directly or under the control of the processor, using other components. The instructions may include a code generated by a compiler or a code executable by an interpreter. The machine-readable storage medium may be provided in the form of a non-transitory storage medium. The “non-transitory” storage medium may not include a signal and is tangible, but does not distinguish whether data is permanently or temporarily stored in a storage medium.

The methods according to the above-described embodiments may be included in a computer program product. The computer program product may be traded as a product between a seller and a consumer. The computer program product may be distributed online in the form of machine-readable storage media (e.g., compact disc read only memory (CD-ROM)) or through an application store (e.g., PLAYSTORE™) or distributed online directly. In the case of online distribution, at least a portion of the computer program product may be at least temporarily stored or temporarily generated in a server of the manufacturer, a server of the application store, or a machine-readable storage medium such as memory of a relay server.

The respective elements (e.g., module or program) mentioned above may include a single entity or a plurality of entities. At least one element or operation from of the corresponding elements mentioned above may be omitted, or at least one other element or operation may be added. Alternatively or additionally, components (e.g., module or program) may be combined to form a single entity. In this configuration, the integrated entity may perform functions of at least one function of an element of each of the plurality of elements in the same manner as or in a similar manner to that performed by the corresponding element from of the plurality of elements before integration. The module, a program module, or operations executed by other elements according to embodiments may be executed consecutively, in parallel, repeatedly, or heuristically, or at least some operations may be executed according to a different order, may be omitted, or the other operation may be added thereto.

While example embodiments of the disclosure have been shown and described, the disclosure is not limited to the aforementioned specific embodiments, and it is apparent that various modifications can be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

1. An electronic device comprising:
a memory configured to store a first artificial intelligence (AI) model and a second AI model; and
a processor configured to:
obtain first data indicating first ratios of monthly predicted sales of respective products of a plurality of products to monthly predicted sales amounts of the plurality of products within a particular period after a current time point by inputting data indicating a monthly sales ratio of each of the plurality of products obtained during a predetermined period before the current time point into the first AI model,
obtain second data indicating second ratios of monthly predicted sales of the plurality of products to all predicted sales amounts of the plurality of products within the particular period after the current time point by inputting data indicating monthly sales amounts of the plurality of products during a predetermined period before the current time point into the second AI model, and
calculate monthly predicted sales ratios of the respective products to the all predicted sales amounts of the plurality of products in the particular period based on the first data and the second data,
wherein the first AI model comprises a neural network model that is different from the second AI model.

2. The electronic device of claim 1, wherein the first AI model is a model trained to predict the monthly sales ratio of respective products of the plurality of products within the particular period based on data related to sales ratios of the respective products to the sales amounts of the plurality of products in a particular month and data related to monthly sales ratios of the respective products to the monthly sales amounts of the plurality of products during a predetermined period in the past prior to the particular month.

3. The electronic device of claim 1, wherein the data related to the monthly sales ratios of the plurality of products comprises data indicating at least one of monthly sales ratios of respective products during the predetermined period, sales ratios of the respective products sold on a monthly basis to a place of sales during the predetermined period, and sales ratios of the respective products expected to be sold on a monthly basis by the place of sales.

4. The electronic device of claim 1, wherein the second AI model is trained to predict the monthly sales ratios of the plurality of products within the particular period based on the data indicating the monthly sales amounts of the plurality of products during the predetermined period in the past prior to a particular year.

5. The electronic device of claim 1, wherein the processor is further configured to calculate monthly predicted sales ratios of respective products to all predicted sales amounts of the plurality of products in the particular period by multiplying the monthly predicted sales ratios of the respective products in the particular period obtained from the first AI model by the monthly predicted sales ratios of the plurality of products obtained from the second AI model.

6. The electronic device of claim 1, wherein the first model comprises a model based on a convolution neural network (CNN), and
wherein the second model comprises a model based on a recurrent neural network (RNN).

7. A method of controlling an electronic device, the method comprising:
obtaining first data indicating first ratios of monthly predicted sales of respective products of a plurality of products to monthly predicted sales amounts of the plurality of products within a particular period after a current time point by inputting data indicating a monthly sales ratio of each of the plurality of products obtained during a predetermined period before the current time point into a first artificial intelligence (AI) model;
obtaining second data indicating second ratios of monthly predicted sales of the plurality of products to all predicted sales amounts of the plurality of products within a particular period after the current time point by inputting data indicating monthly sales amounts of the plurality of products during a predetermined period before the current time point into a second AI model; and
calculating monthly predicted sales ratios of the respective products to the all predicted sales amounts of the plurality of products in the particular period based on the first data and the second data,
wherein the first AI model comprises a neural network model different from the second AI model.

8. The method of claim 7, wherein the first AI model is a model trained to predict the monthly sales ratio of respective products of the plurality of products within the particular period based on data related to sales ratios of the respective products to the sales amounts of the plurality of products in a particular month and data related to monthly sales ratios of the respective products to the monthly sales amounts of the plurality of products during a predetermined period in the past prior to the particular month.

9. The method of claim 7, wherein the data related to the monthly sales ratios of the plurality of products comprises data indicating at least one of monthly sales ratios of respective products during the predetermined period, sales ratios of the respective products sold on a monthly basis to a place of sales during the predetermined period, and sales ratios of the respective products expected to be sold on a monthly basis by the place of sales.

10. The method of claim 7, wherein the second AI model is trained to predict the monthly sales ratios of the plurality of products within the particular period based on the data indicating the monthly sales amounts of the plurality of products during the predetermined period in the past prior to a particular year.

11. The method of claim 7, further comprising:
calculating monthly predicted sales ratios of respective products to all predicted sales amounts of the plurality of products in the particular period by multiplying the monthly predicted sales ratios of the respective products in the particular period obtained from the first AI model by the monthly predicted sales ratio of the plurality of products obtained from the second AI model.

12. The method of claim 7, wherein the first model comprises a model based on a convolution neural network (CNN), and
wherein the second model comprises a model based on a recurrent neural network (RNN).

13. A non-transitory computer-readable medium storing instructions, the instructions comprising: one or more instructions that, when executed by one or more processors of an electronic device, cause the one or more processors to:
obtain first data indicating first ratios of monthly predicted sales of respective products of a plurality of products to monthly predicted sales amounts of the plurality of products within a particular period after a current time point by inputting data indicating a monthly sales ratio of each of the plurality of products obtained during a predetermined period before the current time point into a first artificial intelligence (AI) model,
obtain second data indicating second ratios of monthly predicted sales of the plurality of products to all predicted sales amounts of the plurality of products within the particular period after the current time point by inputting data indicating monthly sales amounts of the plurality of products during a predetermined period before the current time point into a second AI model, and
calculate monthly predicted sales ratios of the respective products to the all predicted sales amounts of the plurality of products in the particular period based on the first data and the second data,
wherein the first AI model comprises a neural network model that is different from the second AI model.

14. The non-transitory computer-readable medium of claim 13, wherein the first AI model is a model trained to predict the monthly sales ratio of respective products of the plurality of products within the particular period based on data related to sales ratios of the respective products to the sales amounts of the plurality of products in a particular month and data related to monthly sales ratios of the respective products to the monthly sales amounts of the plurality of products during a predetermined period in the past prior to the particular month.

15. The non-transitory computer-readable medium of claim 13, wherein the data related to the monthly sales ratios of the plurality of products comprises data indicating at least one of monthly sales ratios of respective products during the predetermined period, sales ratios of the respective products sold on a monthly basis to a place of sales during the predetermined period, and sales ratios of the respective products expected to be sold on a monthly basis by the place of sales.

16. The non-transitory computer-readable medium of claim 13, wherein the second AI model is trained to predict the monthly sales ratios of the plurality of products within the particular period based on the data indicating the monthly sales amounts of the plurality of products during the predetermined period in the past prior to a particular year.

17. The non-transitory computer-readable medium of claim 13, wherein the instructions are further configured to cause the one or more processors to calculate monthly predicted sales ratios of respective products to all predicted sales amounts of the plurality of products in the particular period by multiplying the monthly predicted sales ratios of the respective products in the particular period obtained from the first AI model by the monthly predicted sales ratios of the plurality of products obtained from the second AI model.

18. The non-transitory computer-readable medium of claim 13, wherein the first model comprises a model based on a convolution neural network (CNN), and
wherein the second model comprises a model based on a recurrent neural network (RNN).
